(19) United States
(12) Patent Application Publication
(10) Pub. No.: US 2006/0055502 A1
(43) Pub. Date: Mar. 16, 2006

(54) Humidity sensor

(75) Inventor: Kazuo Usui, Ogaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/178,304

(22) Filed: Jul. 12, 2005

(30) Foreign Application Priority Data
Sep. 16, 2004 (JP) 2004-270466

(51) Int. Cl. H01C 7/00

(52) U.S. Cl. 338/34

(57) ABSTRACT

A humidity sensor includes a substrate, a pair of electrodes disposed opposite to each other with a space on the same plane of the substrate, and a humidity sensitive layer disposed on the substrate to cover the pair of electrodes and the substrate between the pair of electrodes. The layer is made of a humidity sensitive material containing beads. Because the beads having approximately the same size are arranged partially in one layer, the thickness of the humidity sensitive layer can be made uniform using the diameter of the beads as standard.

### CROSS REFERENCE TO RELATED APPLICATION

This application is based on Japanese Patent Application No. 2004-270466 filed on Sep. 16, 2004, the disclosure of which is incorporated herein by reference.

### FIELD OF THE INVENTION

The present invention relates to a humidity sensor.

### BACKGROUND OF THE INVENTION

A humidity sensor having a humidity sensitive layer with a non-uniform thickness shows a low sensing stability. In a humidity sensor, disclosed in Japanese Patent Application Publication No. 2002-71612, the thickness of a humidity sensitive layer is made uniform in order to improve its sensing stability.

As shown in FIG. 3, a humidity sensor 10 includes a substrate 1, a pair of electrodes 2, a humidity sensitive layer 3 and a frame member 5. Each electrode 2 includes a detection part 2a forming into multiple comb-teeth, and an electrode pad 2b. The electrode pads 2b electrically connect between the detection parts 2a and external circuits such as a processing circuit.

The frame member 5 made of a foamed material is formed on the substrate 1 to surround the detection parts 2a, so that the humidity sensitive layer 3 is made uniform. The humidity sensitive layer 3 is formed inside the frame member 5 on the substrate 1 including the area where the detection parts 2a are formed. In the sensor 10, however, the thickness of the humidity sensitive layer 3 is still difficult to be made uniform even when the frame member 5 is provided.

### SUMMARY OF THE INVENTION

In view of the above-described problem, it is an object of the present invention to provide a humidity sensor including a humidity sensitive layer having a uniform thickness.

The humidity sensor includes a substrate, a pair of electrodes and a humidity sensitive layer. The electrodes are arranged on the same plane of the substrate to be opposite to each other with a predetermined space. The humidity sensitive layer is formed on the substrate to cover the electrodes and the substrate between the electrodes. A humidity sensitive material containing granular beads is used for forming the humidity sensitive layer. Therefore, the thickness of the layer can be easily made uniform using the diameter of the beads as standard.

For example, the beads are made of a hygroscopic material, and a dielectric constant of the beads changes in response to a change in humidity. Further, the beads can be made of the same material as the humidity sensitive material. When the beads have approximately spherical shapes having the same size, the beads can be easily arranged partially in one layer on the pair of electrodes and on the surface of the substrate between the pair of the electrodes. In this case, the thickness of the humidity sensitive layer can be made approximately equal to a diameter of the beads.

Furthermore, a protective layer for protecting the pair of electrodes may be positioned inside the humidity sensitive layer.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic perspective view showing a humidity sensor according to an embodiment of the present invention;

FIG. 2 is a cross sectional view showing the humidity sensor taken along line II-II in FIG. 1; and

FIG. 3 is a schematic perspective view showing a conventional humidity sensor according to a prior art.

### DETAILED DESCRIPTION OF THE PREFERRED EMBODIMENTS

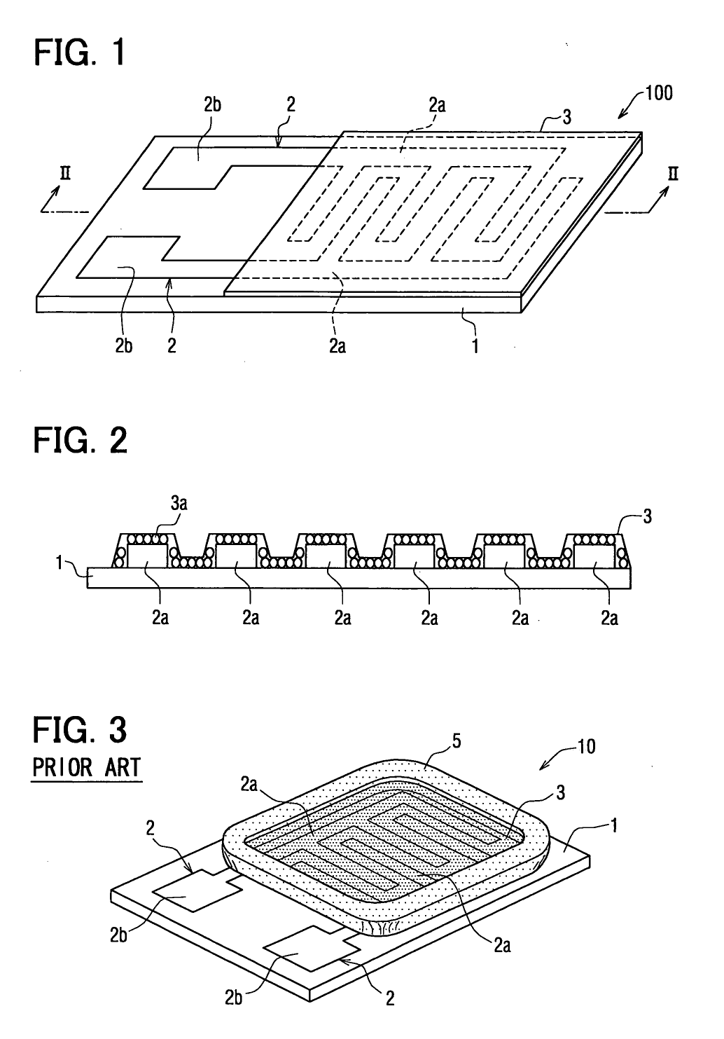

A humidity sensor 100 according to an embodiment of the present invention is shown in FIG. 1. The humidity sensor 100 includes a silicon semiconductor substrate 1, a pair of comb-shaped electrodes 2 and a humidity sensitive layer 3. An insulating layer (not shown) such as a silicon oxide layer is formed on the substrate 1 so that the electrodes 2 are insulated through the insulating layer. The electrodes 2 are arranged on the same plane of the substrate 1 opposite to each other with a predetermined space.

Each of the electrodes 2 includes a detection part 2a and an electrode pad 2b. Each detection part 2a has a common electrode portion and multiple comb-teeth electrode portions extending from the common electrode portion in one direction. The comb-teeth electrode portions of one of the detection parts 2a are arranged alternately with the comb-teeth electrode portions of the other one of the detection parts 2a.

Here, the comb-shaped electrodes 2 are typically used. However, the shape of the electrodes 2 can be suitably changed in the sensor 100. When the comb-shaped electrodes 2 are used, the detection parts 2a can be made opposite to each other along a long distance, and thereby capacitance between the electrodes 2 can be made larger within a small space. In this case, a change rate of capacitance between the electrodes 2, which varies in response to a variation in ambient humidity, increases accordingly. Consequently, humidity sensitivity of the humidity sensor 100 is improved.

The electrode 2 is formed as described below. Firstly, a low resistance metallic material, for example, aluminum, copper, gold, and platinum is deposited on the substrate 1 by a vacuum evaporation or a sputtering. As an example, aluminum is used as a material for forming the electrodes 2. Then, the aluminum layer deposited on the substrate 1 is formed into a comb-teeth pattern by photolithography process. Alternatively, the electrodes 2 can be formed by printing conductive paste on the substrate 1.

A protective layer (not shown) made of silicon nitride is formed on the substrate 1 to cover the electrodes 2. The protective layer is formed by Plasma Chemical Vapor Deposition (Plasma CVD) for example, so as to have a uniform thickness at any point on the substrate 1. If the electrodes 2 have resistance to water-corrosion, the protective layer is not required.

The electrode pads 2b of the electrodes 2 are terminals for connecting external circuits. Through the pads 2b, the humidity sensor 100 is electrically connected to external circuits such as an output correction circuit and a signal processing circuit for detecting a capacitance variation between the detection parts 2a. The pads 2b are not covered with the protective layer in order to connect the external circuits. In the humidity sensor 100, external circuits such as the correction circuit can be formed on the substrate 1 together with the electrodes 2 because the substrate 1 is made of a semiconductor material.

The humidity sensitive layer 3 is formed on the electrodes 2 through a protective layer so as to cover both the detection parts 2a and the substrate 1 between the detection parts 2a. The humidity sensitive layer 3 is made of an organic polymeric material having hygroscopic properties, such as polyimide polymer and cellulose acetate butyrate polymer. As an example, polyimide polymer can be used as a material for the humidity sensitive layer 3. The polyimide polymer is applied on the electrodes 2 through the protective layer by spin coat or printing, and the applied polyimide polymer is hardened, so as to form the humidity sensitive layer 3.

Beads 3a are added in a material for forming the humidity sensitive layer 3. The beads 3a serve to make the thickness of the humidity sensitive layer 3 uniform. The thickness of the humidity sensitive layer 3 is approximately equal to the diameter of the beads 3a. The beads 3a are arranged partially inside the humidity sensitive layer 3 as one layer on surfaces of the substrate 1 and the electrodes 2, and are fixed thereon. Therefore, the thickness of the humidity sensitive layer 3 can be made uniform using the diameter of the beads 3a as standard. Further, the beads 3a serve as a dam and thereby prevent the material for the humidity sensitive layer 3 from spreading over. Spherical beads 3a are typically used as shown in FIG. 2. However, the granular shape of the beads 3 can be suitably changed in the sensor 100.

When the beads 3a are made of a hygroscopic material, the dielectric constant of the beads 3a changes in accordance with the humidity. In this case, the beads 3a prevent degradation of the humidity sensitive properties of the humidity sensitive layer 3, and sensing stability of the sensor 100 can be improved.

Furthermore, the beads 3a can be made of the same humidity sensitive material as the humidity sensitive layer 3. In this case, humidity sensitive properties of the humidity sensitive layer 3 can be made more stable, and sensing stability of the sensor 100 can be improved greatly.

In the sensor 100, when water (moisture) in the air infiltrates into the humidity sensitive layer 3, the dielectric constant of the humidity sensitive layer 3 changes in accordance with the amount of infiltrated water due to a large dielectric constant of water. For example, the dielectric constant of the humidity sensitive layer 3 changes in proportional to the amount of infiltrated water. Then, capacitance between the electrodes 2 changes in response to the change of the dielectric constant of the humidity sensitive layer 3, because a capacitor is constructed with the electrodes 2 using the humidity sensitive layer 3 as a part of dielectric materials. Therefore, the capacitance between the electrodes 2 changes according to the amount of water in the air, i.e., humidity. Besides, the amount of water infiltrated into the humidity sensitive layer 3 depends on humidity around the sensor 100. Therefore, the sensor 100 can detect humidity by detecting the change of the capacitance between the electrodes 2.

In the above-described embodiment, the arrangement pattern of the detection parts 2a of the electrodes 2 can be suitably changed in accordance with the arrangement space of the sensor 100. Furthermore, the other structure of the sensor 100, except for the humidity sensitive layer 3 including the beads 3a, can be suitably changed.

Such changes and modifications are to be understood as being within the scope of the present invention as defined by the appended claims.

What is claimed is:

1. A humidity sensor comprising:
a substrate;
a pair of electrodes disposed on a surface of the substrate opposite to each other with a space; and
a humidity sensitive layer, which covers the pair of electrodes and the substrate between the pair of electrodes, wherein
the humidity sensitive layer is made of a humidity sensitive material containing granular beads.

2. The sensor according to claim 1, wherein
the beads are made of a hygroscopic material, and
a dielectric constant of the beads changes in response to a change in humidity.

3. The sensor according to claim 1, wherein
the beads are made of the same material as the humidity sensitive material.

4. The sensor according to claim 1, wherein
the beads have approximately spherical shapes having the same size.

5. The sensor according to claim 1, wherein
the beads are arranged partially in one layer on the pair of electrodes and on the surface of the substrate between the pair of the electrodes.

6. The sensor according to claim 4, wherein
the humidity sensitive layer has a thickness approximately equal to a diameter of the beads.

7. The sensor according to claim 1, wherein
each of the pair of electrodes includes a common electrode portion and a plurality of comb-teeth electrode portions extending from the common electrode portion in one direction, and
the comb-teeth electrode portions of one of the pair of electrodes and the comb-teeth electrode portions of the other one of the pair of electrodes are alternately arranged with a space.

8. The sensor according to claim 1, further comprising:
a protective layer for protecting the pair of electrodes, wherein
the protective layer is positioned inside the humidity sensitive layer.
